(19) United States
(12) Patent Application Publication
(10) Pub. No.: US 2017/0345428 A1
(43) Pub. Date: Nov. 30, 2017

(54) DOCKING DEVICE FOR PROVIDING COMPUTING SERVICE AND METHOD FOR PROVIDING THE SAME

(71) Applicant: I/O INTERCONNECT, LTD., Santa Ana, CA (US)

(72) Inventors: Johnny Hsiang-Yu CHEN, TAIPEI CITY (TW); Chen-Ming LEE, TAIPEI CITY (TW)

(21) Appl. No.: 15/608,160

(22) Filed: May 30, 2017

Related U.S. Application Data
(60) Provisional application No. 62/343,020, filed on May 30, 2016.

(51) Int. Cl. G10L 15/26; G06F 1/16; G06F 3/16

(52) U.S. Cl. CPC G10L 15/265; G06F 1/1632; G06F 3/16

(57) ABSTRACT

Present disclosure relates to a docking device. The docking device is connected to a computer. The docking device includes a plurality of ports, the ports are configured to connect to a peripheral device and the computer. The docking device further includes a processor, wherein the processor is configured to provide a data aggregation by retrieving information from the peripheral device or the computer.

### CROSS-REFERENCE TO RELATED APPLICATION

This application claims priority to U.S. Provisional Application Ser. No. 62/343,020, filed on May 30, 2016, which is herein incorporated by reference.

### BACKGROUND

### Field of Invention

The present disclosure relates to an interface device, and a method for operating the interface device. More particularly, the present invention relates to a docking device for providing computing service and a method for providing the same.

### Description of Related Art

Thanks to the improvements of USB technology, more and more interface devices are provided to people. However, most of current interface devices are passive devices provided as simple intermediates. None of them provides more smart or sophisticated services. Although there may have some software provided to associate with such an interface device, the service it may provide is still limited. Therefore, how to provide an active interface device that has smart or sophisticated services is a challenge to people in the art.

### SUMMARY

The disclosure provides a docking device connected to a computer. The docking device comprises a plurality of ports and a processor. The ports are configured to connect to a peripheral device and the computer. The processor is configured to provide a data aggregation by retrieving information from the peripheral device or the computer.

Another aspect of the disclosure is to provide a method for providing computing device, wherein the method comprises: electrically connecting a peripheral device and a computer to a plurality of ports of a docking device; and providing, by a processor, a data aggregation by retrieving information from the peripheral device or the computer.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a docking device according to some embodiments of the present disclosure;

FIG. 2 is a schematic diagram of a docking device according to some embodiments of the present disclosure;

FIG. 3 is a schematic diagram of a docking device according to some embodiments of the present disclosure;

FIG. 4 is a schematic diagram of a docking device according to some embodiments of the present disclosure;

FIG. 5 is a schematic diagram of a docking device according to some embodiments of the present disclosure; and

FIG. 6 is a flow chart of a method for providing computing device according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

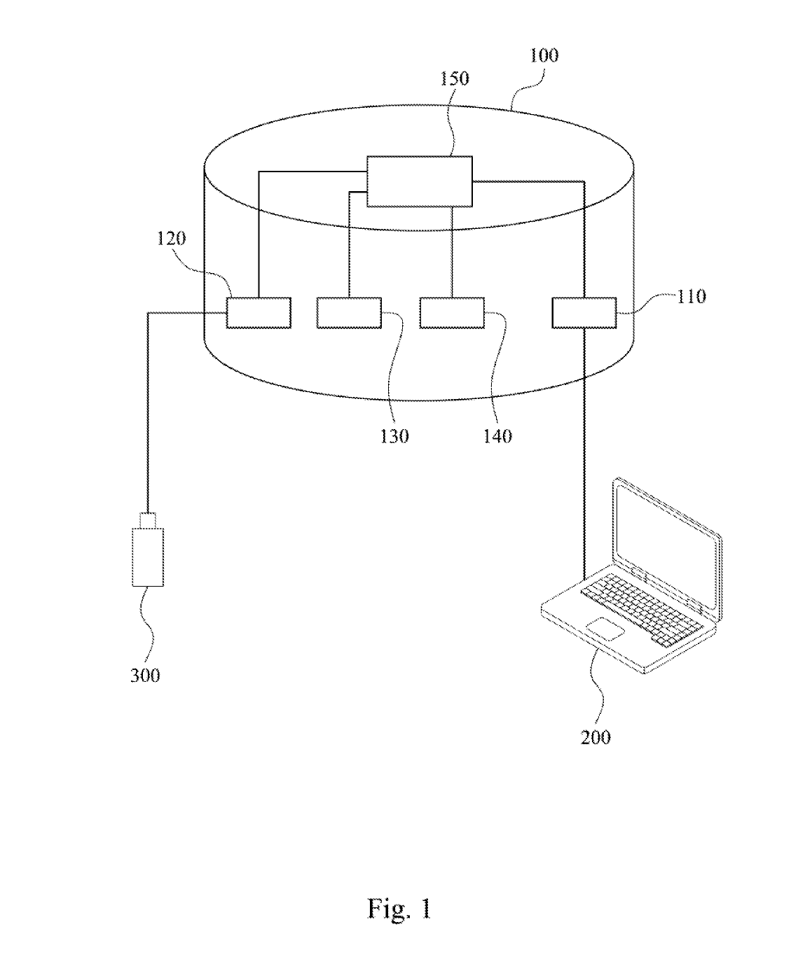

FIG. 1 is a schematic diagram of a docking device according to some embodiments of the present disclosure. As illustrated in FIG. 1, the docking device 100 includes a first port 110, a second port 120, a third port 130, a fourth port 140 and a processor 150. The processor 150 is in electrical connection with all of the first port 110, the second port 120, the third port 130 and the fourth port 140. In the embodiment, a laptop 200 is connected to the docking device 100 via the first port 110 and a flash drive 300 is connected to the docking device 100 via the second port 120. Therefore, the processor 150 is in connection with the laptop 200 and flash drive 300. The docking device 100 may be provided with control software, which is either embedded in the docking device 100 or provided by the operation system of the laptop 200. The operation system of the laptop 200 may be Microsoft Windows or Mac OS. The number of ports drawn in FIG. 1 is used for the purpose of explanation instead of limitation.

In foregoing embodiment, the third port 130 or the fourth port 140 may be provided for connecting to several interfaces, such as mobile phones, tablets, audio input devices, audio output devices, video input devices, video output devices, network cables, wireless network interfaces, security digital cards, other storage devices, etc. By connecting to the laptop 200, the flash drive 300 or aforesaid peripheral devices, the processor 150 is configured to provide an operation of data aggregation.

The operation of data aggregation regards to the data management to these devices connected to the docking device 100, such as storage contents or usage statistics management. Storage contents herein may refer to the data contents stored in some storage devices that have ever or are currently connected to the docking device 100. Mentioned storage devices include USB (Universal Serial Bus) flash drives, security digital (SD) cards, hard disk drives (HDD) or solid-state drives (SSD). Data contents herein are typically refer to files stored in the storage devices, data stored in a database such as Microsoft SQL Server, or data in application-specific format such as DOC file of Word. In the embodiment, since the flash drive 300 and the laptop 200 are connected to the docking device 100, therefore the storage contents in the flash drive 300 and the laptop 200 may be accessed by the processor 150.

In the embodiment, the operation of data aggregation includes indexing the data contents to enhance the function of file searching or file sorting. The indexing process is provided by the processor 150 to obtain data contents and storage hierarchies of the flash drive 300 and the laptop 200. Files stored in the flash drive 300 and the laptop 200 may be indexed by their name, size, created date, etc. A file contains textual information may be indexed by parsing part of the textual information as keywords. A file of photograph may be indexed according to the date, the location or the weather that photograph being taken. The weather information of mentioned photograph file may be obtained by referencing to some weather service applications. Also, since the date of the photograph being taken may be obtained, the file of photograph may be indexed by determining whether the date is a weekend day, holiday or birthday. The date determination of mentioned photograph file may be executed by referencing to the calendar of a user.

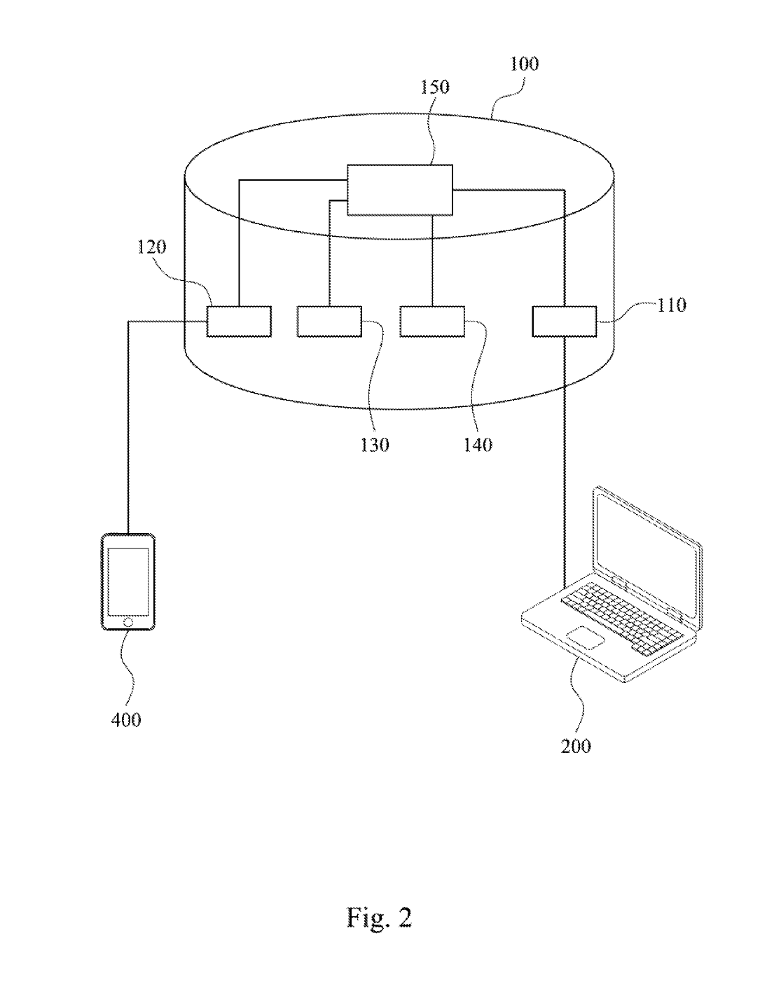

FIG. 2 is a schematic diagram of a docking device according to some embodiments of the present disclosure. As illustrated in FIG. 1, the docking device 100 includes a first port 110, a second port 120, a third port 130, a fourth port 140 and a processor 150. The processor 150 is in electrical connection with all of the first port 110, the second port 120, the third port 130 and the fourth port 140. In the embodiment, a laptop 200 is connected to the docking device 100 via the first port 110 and a mobile phone 400 is connected to the docking device 100 via the second port 120. Therefore, the processor 150 is in connection with the laptop 200 and the mobile phone 400. The docking device 100 may be provided with control software, which is either embedded in the docking device 100 or provided by the operation system of the laptop 200.

By connecting to the laptop 200 and the mobile phone 400, the processor 150 is configured to provide an operation of data aggregation. The operation of data aggregation regards to the data management to these devices connected to the docking device 100, such as storage contents or usage statistics management. Storage contents herein may refer to the data contents stored in the laptop 200 and the mobile phone 400 connected to the docking device 100. In the embodiment, the operation of data aggregation includes indexing the data contents to enhance the function of file searching or file sorting. The indexing process is provided by the processor 150 to obtain data contents and storage hierarchies of the laptop 200 and the mobile phone 400. Files stored in the laptop 200 and the mobile phone 400 may be indexed by their name, size, created date, etc. A file contains textual information may be indexed by parsing part of the textual information as keywords. A file of photograph may be indexed according to the date, the location or the weather that photograph being taken. The weather information of mentioned photograph file may be obtained by referencing to some weather service applications. Also, since the date of the photograph being taken may be obtained, the file of photograph may be indexed by determining whether the date is a weekend day, holiday or birthday. The date determination of mentioned photograph file may be executed by referencing to the calendar of a user.

In the embodiment, the operation of data aggregation relates to usage statistics management as well. The docking device 100 is configured with an electricity detector (not shown). When the mobile phone 400 is connected to the docking device 100, the docking device 100 may not only provide current to charge the mobile phone 400 but measure the battery of the mobile phone 400. Via the electricity detector, the processor 150 of the docking device 100 may measure the power consumption of the mobile phone 400 and provide a power consumption report. Via the electricity detector, the processor 150 of the docking device 100 may detect the remaining power of the mobile phone 400 and estimate to provide an operation time report. Such dock may have some sort of electric meter built-in, which may be utilized to meter the wattage flow. The wattage flow information may not only be utilized to accumulated electricity cost but calculate the remaining usable time of the mobile phone 400.

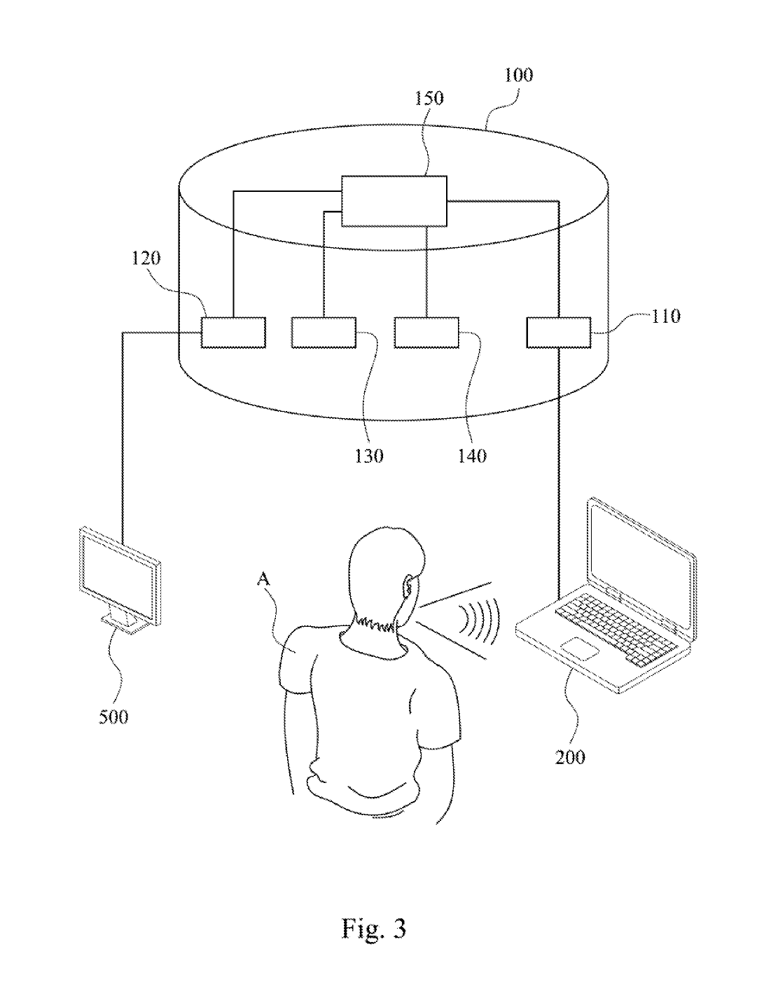

FIG. 3 is a schematic diagram of a docking device according to some embodiments of the present disclosure. As illustrated in FIG. 3, the docking device 100 includes a first port 110, a second port 120, a third port 130, a fourth port 140 and a processor 150. The processor 150 is in electrical connection with all of the first port 110, the second port 120, the third port 130 and the fourth port 140. In the embodiment, a laptop 200 is connected to the docking device 100 via the first port 110 and a monitor 500 is connected to the docking device 100 via the second port 120. Therefore, the processor 150 is in connection with the laptop 200 and the monitor 500. The docking device 100 may be provided with control software, which is either embedded in the docking device 100 or provided by the operation system of the laptop 200.

By connecting to the laptop 200 and the monitor 500, the docking device 100 is configured to provide an operation of voice command. The operation of voice command is to provide an efficient and intuitive method for controlling these devices connected to the docking device 100. In the embodiment, voice command software may be installed on laptop 200 for processing voice commands from a user A. As an example, Cortana of Microsoft Windows 10 may be utilized as the voice command software. The user A may speak out a command sentence. The command sentence may be received by the laptop 200 and processed by the voice command software. The voice command software then sent the command sentence to the processor 150 of the docking device 100. By delivering the command sentence to the monitor 500, the monitor 500 may be controlled by the command sentence from the user A.

In such configuration, when user A speaks a command sentence as “mirror display” to the laptop 200, the command sentence may be recognized and sent to the docking device 100. The command sentence is then relayed to the monitor 500. The monitor 500 operates as a mirror display of the laptop 200. When user A speaks a command sentence as “extended display” to the laptop 200. The command sentence may be sent to the docking device 100 and relayed to the monitor 500. The monitor 500 operates as an extension display of the laptop 200. When user A speaks a command sentence as “turn off display” to the laptop 200. The command sentence may be sent to the docking device 100 and relayed to the monitor 500. The monitor 500 receives the command sentence and being turned off.

In some embodiments, the command sentences made to the monitor 500 may be provided with direction references. For example, when the command sentence is “extended display on top”, the monitor 500 may operate as an extension display extended from the top margin of the laptop 200. In a modified configuration, when the command sentence is “extended display”, the monitor 500 operates as an extension display of the laptop 200. Moreover, the processor 150 may send a response to the laptop 200 for asking the user A to define the direction reference, a response sentence may be provided by the voice command software to ask the user A about “which side”. When the user A makes further command sentence regarding to direction reference, the monitor 500 performs in accordance with the command sentence.

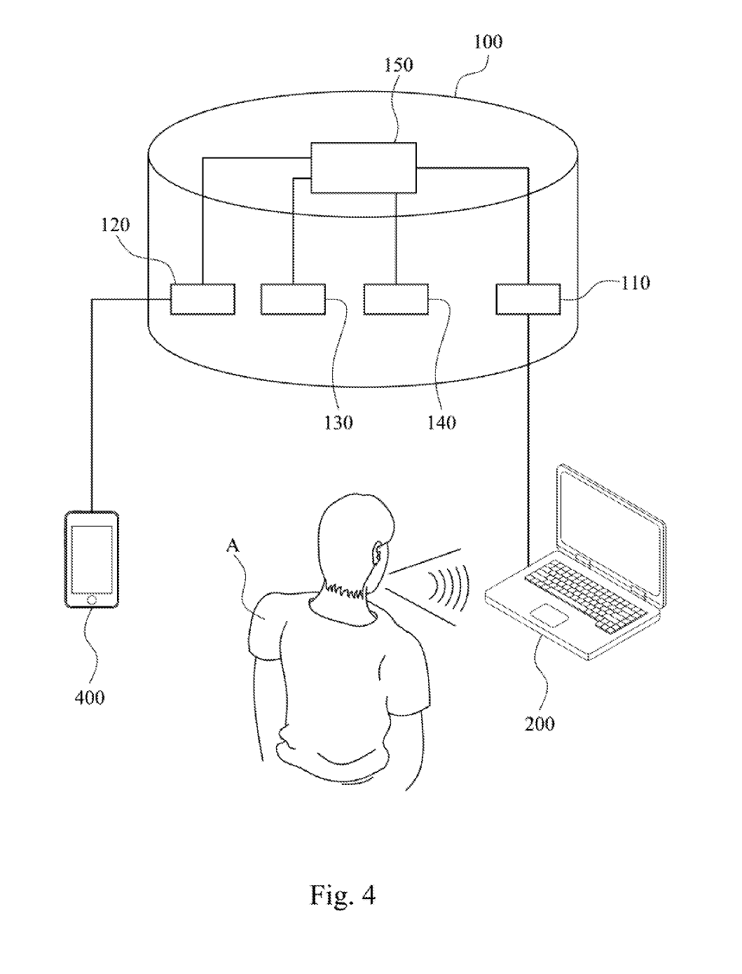

FIG. 4 is a schematic diagram of a docking device according to some embodiments of the present disclosure. As illustrated in FIG. 4, the docking device 100 includes a first port 110, a second port 120, a third port 130, a fourth port 140 and a processor 150. The processor 150 is in electrical connection with all of the first port 110, the second port 120, the third port 130 and the fourth port 140. In the embodiment, a laptop 200 is connected to the docking device 100 via the first port 110 and a mobile phone 400 is connected to the docking device 100 via the second port 120. Therefore, the processor 150 is in connection with the laptop 200 and the mobile phone 400. The docking device 100 may be provided with control software, which is either embedded in the docking device 100 or provided by the operation system of the laptop 200.

By connecting to the laptop 200 and the mobile phone 400, the docking device 100 is configured to provide an operation of voice command. In the embodiment, voice command software may be installed on laptop 200 for processing voice commands from a user A. The user A may speak out a command sentence. The command sentence may be received by the laptop 200 and processed by the voice command software. The voice command software then sent the command sentence to the processor 150 of the docking device 100. By delivering the command sentence to the mobile phone 400, the mobile phone 400 may be controlled by the command sentence from the user A.

In such configuration, when user A speaks a command sentence as “fast charge my phone” to the laptop 200, the command sentence may be recognized and sent to the docking device 100. The command sentence is then relayed to the mobile phone 400. The mobile phone 400 receives the command sentence and operates in fast charge mode. When user A speaks a command sentence as “turn off charging” to the laptop 200. The command sentence may be sent to the docking device 100 and relayed to the mobile phone 400. The mobile phone 400 receives the command sentence and operates in normal connection mode.

Moreover, when multiple phones are connected to the docking device 100, the command sentence may be provided with specific indications. For example, when the command sentence is “fast charge my phone on the third port”, the processor 150 may only deliver the command sentence to the phone connected to the third port. Therefore, only the phone connected to the third port would be switched to fast charge mode. In a modified configuration, when the user A speaks a command sentence “fast charge my phone” without specific indications when there are multiple phones connected to the docking device 100, the processor 150 may send a response to the laptop 200 for asking the user A to define which phone should be charged. A response sentence may be provided by the voice command software to ask the user A about “which port”. When the user A makes further command sentence regarding to a specific port, the phone connected via that port would be switched to fast charge mode.

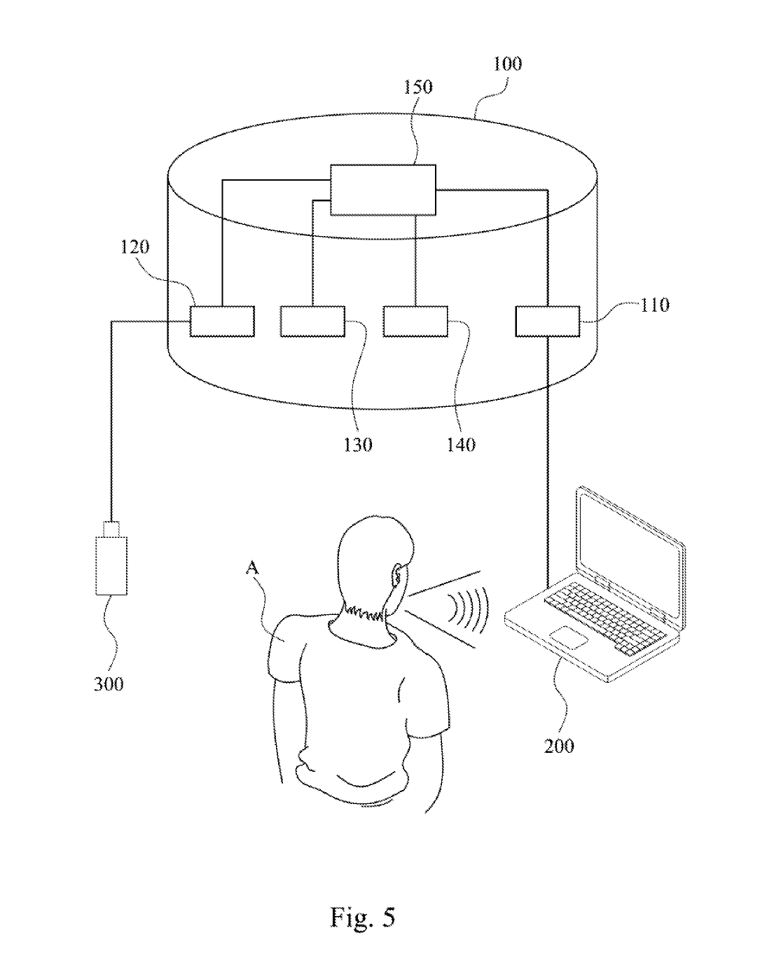

FIG. 5 is a schematic diagram of a docking device according to some embodiments of the present disclosure. As illustrated in FIG. 5, the docking device 100 includes a first port 110, a second port 120, a third port 130, a fourth port 140 and a processor 150. The processor 150 is in electrical connection with all of the first port 110, the second port 120, the third port 130 and the fourth port 140. In the embodiment, a laptop 200 is connected to the docking device 100 via the first port 110 and a flash drive 300 is connected to the docking device 100 via the second port 120. Therefore, the processor 150 is in connection with the laptop 200 and the flash drive 300. The docking device 100 may be provided with control software, which is either embedded in the docking device 100 or provided by the operation system of the laptop 200.

By connecting to the laptop 200 and the flash drive 300, the docking device 100 is configured to provide an operation of voice command. In the embodiment, voice command software may be installed on laptop 200 for processing voice commands from a user A. The user A may speak out a command sentence. The command sentence may be received by the laptop 200 and processed by the voice command software. The voice command software then sent the command sentence to the processor 150 of the docking device 100. By delivering the command sentence to the flash drive 300, the flash drive 300 may be controlled by the command sentence from the user A.

In such configuration, when user A speaks a command sentence as “open my drive” to the laptop 200, the command sentence may be recognized and sent to the docking device 100. The command sentence is then relayed to the flash drive 300. The data stored in the flash drive 300 may be accessed and displayed on the laptop 200. When user A speaks a command sentence as “eject my drive” to the laptop 200. The command sentence may be sent to the docking device 100 and relayed to the flash drive 300. Therefore, the flash drive 300 would be disconnected from laptop 200.

In a modified configuration, the user A may speak out a command sentence with specific indications when there are multiple storage devices being connected to the docking device 100. For example, the command sentence would only be delivered to the storage device connected to the third port when the command sentence is “open my drive on the third port”. The data stored in the storage device connected to the third port may be accessed and displayed on the laptop 200. As the same, the command sentence would only be delivered to the storage device connected to the third port when the command sentence is “eject my drive on the third port”. The storage device connected to the third port would be disconnected from laptop 200.

Moreover, in some embodiments, the docking device 100 is provided with a voice receiver and corresponding voice command software. The user A may speak out a command sentence to the docking device 100. The voice receiver of the docking device 100 may receive the command sentence. The processor 150 of the docking device 100 may relay the command sentence to the peripheral devices connected to the docking device. Therefore the peripheral devices may be controlled by the command sentence accordingly.

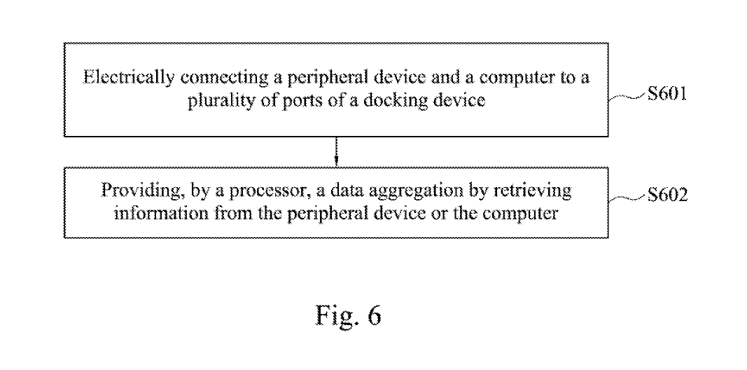

FIG. 6 is a flow chart of a method for providing computing device according to some embodiments of the present disclosure. The steps of the method will be listed and explained in detail in following segments.

Step S601: Electrically connecting a peripheral device and a computer to a plurality of ports of a docking device. As illustrated in FIG. 1 to FIG. 5, the laptop 200, the flash drive 300, the mobile phone 400 and the monitor 500 are connected to the docking device 100 via the first port 110 and the second port 120. Through these ports, the laptop 200, the flash drive 300, the mobile phone 400 and the monitor 500 are in electrical connection with the processor 150 of the docking device 100.

Step S602: Providing, by a processor, a data aggregation by retrieving information from the peripheral device or the computer. As illustrated in FIG. 1, FIG. 2, FIG. 4 and FIG. 5, the laptop 200, the flash drive 300 and the mobile phone 400 connected to the docking device 100 are provided with data aggregation operation. The operation of data aggregation regards to the data management to these devices connected to the docking device 100, such as storage contents or usage statistics management. In some embodiments, the operation of data aggregation includes indexing the data contents to enhance the function of file searching or file sorting. Files stored in the peripheral devices may be indexed by their name, size, created date, etc.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A docking device, connected to a computer, comprising:
a plurality of ports, configured to connect to a peripheral device and the computer; and
a processor, configured to provide a data aggregation by retrieving information from the peripheral device or the computer.

2. The docking device of claim 1, wherein the processor is further configured to operate the peripheral device according to a voice command, wherein the voice command is obtained by the docking device or the computer.

3. The docking device of claim 2, wherein the voice command includes controlling the peripheral device, charging the peripheral device, connecting or disconnecting the peripheral device.

4. The docking device of claim 1, wherein the data aggregation includes obtaining storage contents of the peripheral device or the computer.

5. The docking device of claim 1, wherein the data aggregation includes obtaining storage hierarchies of the peripheral device or the computer.

6. The docking device of claim 1, wherein the data aggregation includes obtaining usage statistics of the peripheral device or the computer. The docking device of claim 6, wherein the usage statistics includes a power consumption report or an operation time report.

8. The docking device of claim 1, wherein the data aggregation includes generating an index for storage contents of the peripheral device or the computer.

9. The docking device of claim 8, wherein the data aggregation includes searching or sorting storage contents according to the index.

10. The docking device of claim 1, wherein the peripheral device is selected from a group consisting of a USB (Universal Serial Bus) flash drive, a SD (Secure Digital) card, a HDD (Hard Disk Drive), a SSD (Solid State Disk), a mobile phone, a tablet, a monitor and combination thereof.

11. A method for providing computing device, comprising:
electrically connecting a peripheral device and a computer to a plurality of ports of a docking device; and
providing, by a processor, a data aggregation by retrieving information from the peripheral device or the computer.

12. The method of claim 11, including:
obtaining a voice command by the docking device or the computer;
operating, by the processor, the peripheral device according to a voice command.

13. The method of claim 12, wherein the voice command includes controlling the peripheral device, charging the peripheral device, connecting or disconnecting the peripheral device.

14. The method of claim 11, wherein the data aggregation includes obtaining storage contents of the peripheral device or the computer.

15. The method of claim 11, wherein the data aggregation includes obtaining storage hierarchies of the peripheral device or the computer.

16. The method of claim 11, wherein the data aggregation includes obtaining usage statistics of the peripheral device or the computer.

17. The method of claim 16, wherein the usage statistics includes a power consumption report or an operation time report.

18. The method of claim 11, wherein the data aggregation includes generating an index for storage contents of the peripheral device or the computer.

19. The method of claim 18, wherein the data aggregation includes searching or sorting storage contents according to the index.

20. The method of claim 11, wherein the peripheral device is selected from a group consisting of a USB (Universal Serial Bus) flash drive, a SD (Secure Digital) card, a HDD (Hard Disk Drive), a SSD (Solid State Disk), a mobile phone, a tablet, a monitor and combination thereof.
